(19) United States
(12) Patent Application Publication
(10) Pub. No.: US 2014/0274508 A1
(43) Pub. Date: Sep. 18, 2014

(54) EFFICIENCY BOOST OF POWER TRANSMISSION TO THE FRONT END ACCESSORY DRIVE

(71) Applicant: Robert James Crist, Bentonville, AR (US)

(72) Inventor: Robert James Crist, Bentonville, AR (US)

(73) Assignee: DAYCO IP HOLDINGS, LLC, Springfield, MO (US)

(21) Appl. No.: 14/211,377

(22) Filed: Mar. 14, 2014

Related U.S. Application Data
(60) Provisional application No. 61/794,429, filed on Mar. 15, 2013.

(51) Int. Cl. F16H 57/00

(52) U.S. Cl. CPC F16H 57/0006
USPC 474/94

(57) ABSTRACT

An efficiency boost of power transmission to the front end accessory drive (“FEAD”) system is provided by a crankshaft damper having a hub, an inertia member operably attached to the hub by an elastomeric member, and a one-way clutch operably attached to the inertia member and to drive a belt-engaging surface. The one-way clutch is operably associated with the crankshaft damper for increasing the average RPM input to the FEAD system relative to the average crankshaft input.

### RELATED APPLICATIONS

This application claims the benefit of U.S. Provisional Application No. 61/794,429, filed Mar. 15, 2013.

### FIELD OF THE DISCLOSURE

The present invention relates to vehicle engines and, more particularly, to a front end accessory drive system wherein the efficiency of the power transmission to the front end accessory drive system is boosted via complementary, magnified input from a crankshaft damper.

### BACKGROUND

Originally a crankshaft drove the front end assembly drive (FEAD) system of an engine. The crankshaft was turned by the firing of pistons, which exerted a rhythmic torque on the crankshaft, rather than being continuous. This constant application and release of torque caused vacillations, which would stress the crankshaft to the point of failure. Stated another way the crankshaft is like a plain torsion-bar, which has a mass and a torsional spring rate, that causes the crankshaft to have its own torsional resonant frequency. The torque peaks and valleys plus the inertia load from the acceleration of the reciprocating components cause the crankshaft itself to deflect (rotationally) forward and backward while it is operating. When those pulses are near the crankshaft resonant frequency, they would cause the crank to vibrate uncontrollably and eventually break.

A crankshaft damper was introduced to solve this problem and currently also drives the FEAD system. The two primary functions of the crankshaft damper, i.e., producing a counteracting torque to the crank negating the torque twisting amplitude placed upon the crankshaft by periodic firing impulses; and transferring rotational motion into the FEAD system, the event of the two simultaneous functions creates an opportunity in the dynamics of the drive force.

When the crankshaft experiences a twisting motion from the firing of pistons, or when a crankshaft damper inertia magnifies that twisting input (function 1), and the same drive device is used to drive the FEAD system (function 2), then there is an oscillating dynamic motion superimposed upon the prevailing RPM of the FEAD system. In this case, the oscillating dynamic motion is both complementary to the driving direction and is also detrimental thereto.

Thus, an unaddressed need exists in the industry to address these deficiencies and inadequacies.

### SUMMARY

The present disclosure provides crankshaft dampers and front end accessory drive (FEAD) systems that will boost the efficiency of the power transmission to the FEAD system via complimentary, magnified input from the crankshaft damper, by eliminating the detrimental aspect of the rotation of the crankshaft.

In one embodiment, the FEAD system includes a crankshaft damper having a hub mountable on a crankshaft, an elastomeric member disposed in contact with the hub, an inertia member seated against the elastomeric member thereby operably coupling the inertia member to the hub, and a one-way clutch operably coupled to the inertia member, the one-way clutch having an engaged position and a disengaged position. The one-way clutch defines a belt-engaging surface or has a pulley body, defining a belt-engaging surface, seated thereagainst. During operation, when the one-way clutch is in the engaged position the belt-engaging surface rotates with the hub in the prevailing direction and when the one-way clutch is in the disengaged position, the belt engaging surface continues to rotate in the prevailing direction, and when the one-way clutch transitions from a disengaged position to an engaged position, a magnification factor experienced by the inertia member is transferred by the one-way clutch from the crankshaft damper assembly to boost the revolutions-per-minute (RPMs), such that the average rotational angular speed of the belt driving surface is greater than that of the crankshaft or crankshaft nose.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of components in an efficiency boost of power transmission to the front end accessory drive.

FIG. 2A is longitudinal cross-sectional view of one embodiment of a crankshaft damper with boost capability.

FIG. 2B is transverse cross-sectional view the crankshaft damper of FIG. 2A.

FIG. 3 is a longitudinal cross-sectional view of an alternate embodiment of a crankshaft damper with boost capability.

### DETAILED DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

Currently, a front end assembly drive system is driven by a crankshaft damper mounted on the front of a vehicle engine, which does not and cannot harness the positive dynamic amplitude magnification of the crankshaft damper inertia member to boost RPM input to the FEAD system.

An efficiency boost of power transmission to the FEAD as described below, provides a unique solution to boost RPMs in the FEAD system under certain operating conditions. The system includes a crankshaft damper designed to harness the one-way, positive dynamic amplitude of the crankshaft damper inertia member to boost the RPM input to the FEAD system for the same crank input. The efficiency boost of power transmission to the FEAD will not only boost the RPM input, but it also increases mean power transmission to the FEAD.

FIG. 1 illustrate a FEAD system 118 that includes an integrated housing 115, having a front surface 130 and a rear surface 127. The rear surface 127 of the integrated housing 115 is preferably mounted to an engine, such as an automobile engine. The FEAD system 118 may be utilized with any engine, including applications such as vehicle, marine and stationary. The shape and configuration of the integrated housing 115 depends upon the vehicle engine to which it is to be mounted. Accordingly, the integrated housing 115 and more specifically the FEAD system 118 may vary along with the location of engine drive accessories 109 and still achieve the objects of the present invention. The integrated housing 115 and FEAD system 118 in FIG. 1 are merely illustrative.

The integrated housing 115 can be designed to have all of the engine drive accessories 109 attached to its front surface 130. Alternately, the engine drive accessories 109, the alternator 112 and the belt tensioner 121 may be mounted to a front face of the engine. It should be understood that the location and number of engine drive accessories 109 may be varied. For example, a vacuum pump, a fuel injection pump, an oil pump, a water pump, a power steering pump, an air conditioning pump, and a cam drive are examples of other engine drive accessories 109 that may be mounted on the integrated housing 115, for incorporation into the FEAD system 118. Still referring to FIG. 1, the integrated housing 115 has a plurality of engine drive accessories 109 including an alternator 112, and also includes a crankshaft damper 103, and a belt tensioner 121.

The engine drive accessories 109 are driven by at least one endless drive belt 106, which may be a flat belt, a rounded belt, a V-belt, a multi-groove belt, a ribbed belt, a cogged belt, etc., or a combination of the aforementioned belts, being single or double sided. The endless drive belt 106 may be a serpentine belt, and is wound around the engine drive accessories 109, including the alternator 112 and the crankshaft damper 103, which is connected to the nose 110 of the crankshaft 114. The crankshaft 114 drives the crankshaft damper 103, which drives the endless drive belt 106, which in turn drives the remaining engine drive accessories 109. The belt tensioner 121 automatically adjusts the tension of the endless drive belt 109 to keep it tight during operation.

Referring now to FIGS. 2-3, the boost of the RPMs in the FEAD system, discussed above, is the result of a crankshaft damper, such as exemplary crankshaft dampers 303, 304 of FIGS. 2A and 2B and FIG. 3 respectively, secured to a crankshaft. Each crankshaft damper 303, 304 has been enhanced to include a one-way clutch 330 operatively attached to an inertia member 321 thereof and being concentrically positioned relative to the inertia member 321.

With reference to FIG. 2A, the crankshaft damper 303 includes, from most proximate to the crankshaft to most distal therefrom in order, a hub 306, an annular elastomeric member 312, the inertia member 321, the one-way clutch 330 and a pulley body 330 having belt-engaging surface 340. Based on this order of the components, each consecutively listed component is concentric about the component that is more proximate the crankshaft C and is operatively coupled to that component. Typically the components are operatively coupled to the adjacent component for rotation therewith. However, the one-way clutch 330 while being operatively coupled to two components, the pulley body 339 and the inertia member 321, is selectively coupleable to allow the rotation of the pulley body 339 with the inertia member 321 in the prevailing rotational direction, but not in the opposite direction due to free disengagement.

The hub 306 includes a central bore 350 for receiving the crankshaft C for rotational movement therewith and has a flange 310. The hub 306 may be made from cast iron, steel, aluminum, other suitable metals, plastics, composites, or a combination thereof

The inertia member 321 may be made from any material having a sufficient inertia, usually cast iron, steel, or similar dense material. As illustrated in FIGS. 2A and 2B, the inertia member 321 is concentric with and spaced radially outward from the hub 306 such that an outer surface 307 of the flange 310 of hub 306 faces an inner surface 322 of the inertia member 321 and defines a gap therebetween. The elastomeric member 312 may be press fit or injected into this gap so as to non-rigidly couple the hub 306 and the inertia member 321. The elastomeric member 312 may be an elastomer (a polymer having the property of viscoelasticity, of generally low tensile modulus and high yield strain). The elastomeric member 312 may, however, be as disclosed in U.S. Pat. No. 7,658,127, which is incorporated herein, in its entirety, by reference. In another embodiment, the elastomeric member 312 may be attached to the outer surface 307 and the inner surface 322 using a conventional adhesive known for use in vibration damping systems. Some examples of suitable adhesives include rubber bonding adhesives sold by the Lord Corporation, Henkel AG & Co., or Morton International Incorporated Adhesives & Specialty Company.

Still referring to FIGS. 2A and 2B, the one-way drive device 330 is concentric with and spaced radially outward from the inertia member 321 and may include an inner ring 327 operably attached to an outer surface 324 of the inertia member 321, for example, but not limited to, by a press fit. Alternately, the features that would be present in the inner ring 327 to enable the coupling/decoupling of the one way clutch may be formed directly into the outer surface of the inertia member 321. The one-way drive device 330 includes an outer ring 333, concentric about the inner ring 327, that includes the remainder of the necessary features for the one-way clutch 330 to couple/decouple the components of the crankshaft damper together. In one embodiment, the outer ring 333 has the belt-engaging surface 340 formed directly therein such that no separate pulley body 339 is required (or conversely, the features of the one-way clutch are formed directly into the pulley body 339 and no separate outer ring 333 is required). In another embodiment, the outer ring 333 is a separate and distinct component relative to the belt engaging member 339 and is coupled to its inner surface 342.

To accomplish the coupling/decoupling of the one-way clutch 330, one or more engagement members 336 may be retained between the inertia member 321 and the belt engaging member 339 (or between the inner ring 327 and outer ring 333). The engagement members 336 may be, but is not limited to, springs, pawls, rolling elements, levers, cantilevers, cammed surfaces, and combinations thereof, or other known means for activating/deactivating a one-way clutch. Many types and configurations of one-way clutches are known to one of skill in the art, which can be selected and or modified to operate within the crankshaft damper 303. The one-way clutch 330 may be, but is not limited to, a sprag or cam clutch, a pawl clutch, or a mechanical diode one-way clutch. “One-way clutch” as used herein can also be referred to as a freewheel, overrunning, backstop, or indexing clutch in reference to its construction. .

With reference to FIG. 3, another embodiment of a crankshaft damper, generally designated by reference numeral 304, to boost the RPM input to the FEAD system. The crankshaft damper 304 includes, from most distal the crankshaft to more proximate the crankshaft in order, a belt-engaging surface 340 of a pulley body 339, a flange 310 of the hub 306, an annular elastomeric member 312, an inertia member 321, a one-way clutch 330, and a side wall 344 of the pulley body 339. Based on this order of the components, each consecutively listed component is concentric about the component that is more proximate the crankshaft C and is operatively coupled to that component. Typically the components are operatively coupled to the adjacent component for rotation therewith. However, the one-way clutch 330 while being operatively coupled to two components, the pulley body 339 and the inertia member 321, is selectively coupleable to allow the rotation of the pulley body 339 with the inertia member 321 in the prevailing rotational direction, but not in the opposite direction.

As seen in FIG. 3, in this embodiment, the inertia member 321 is concentric with and spaced radially inward relative to the elastomeric member 312, which is concentric with and spaced radially inward of the flange 310 of the hub 306. The one-way clutch 330 is disposed concentric with and spaced radially inward relative to the inertia member 321, but is concentric with and spaced radially outward relative to the side wall 244 of the pulley body. This construction may be advantageous because the overall dimensions of the one-way clutch 330 may be smaller than those in the embodiment of FIG. 2A.

As explained above, the one-way clutch 330 may include and inner ring and an outer ring with one or more engagement members therebetween (shown in FIG. 2B) where the inner ring and outer ring may be discrete separate components of the crankshaft damper or one may be built into the inertia member 321 and the other may be built into the pulley body 339 (or vice versa, the ring forms the pulley body). In one embodiment, as shown in FIG. 3, the pulley body 339 is a separate component of the crankshaft damper 304 and defines the belt-engaging surface 340 as part of annular end cap that encloses a flange 310 of the hub 306, the elastomeric member 312, the inertia member 321, and the one-way clutch 330 between the portion defining the belt engaging surface 340 and an opposing side wall 344.

In further explanation, the crankshaft is driven by the reciprocating motion of pistons (not shown) of the vehicle engine, as is well known. The combustion forces that are induced upon the crankshaft by the pistons introduce pulses that act to spin the crankshaft. The rotation of the crankshaft appears to be “smooth”, but in actuality between firing pulses of the engine there is a relative deceleration of the crankshaft, which when combined with pulsing create a rhythmic pattern of acceleration and deceleration that create speed fluctuation relative to the mean average RPM. As the pistons are acted upon by forces of combustion it causes the crankshaft to rotate in a first (“prevailing”) direction, which causes the components of the one way clutch in both embodiment, such as the inner ring 327 or the component having the features typically present in the inner ring (the inertia member 321 in FIG. 2A and 3) to turn in the prevailing direction (which indicates the inner ring locking direction) relative to the outer ring, the engagement members 336 move into a coupled position. In the coupled position, the inner ring, and the outer ring are connected, and torque is transmitted by them so that the components of the crankshaft damper rotate together and hence drive a belt engaged with the belt engaging member.

The crankshaft dampers disclosed herein are constructed to take advantage, during the periods of deceleration experienced by the crankshaft in the mid to upper range RPMs of an engine, the magnification factor of the inertia member in resonance. During the deceleration experienced by the crankshaft, the one-way clutch disengages, and upon the periodic change to an acceleration, the one-way clutch returns to the engaged position and thereby utilizes the physics of the mass-elastic system provided by the elastomeric member and the inertia member to transfer the magnification factor of the inertia member in resonance through the one-way clutch to the belt driving surface and hence into the belt. The net effect is that the average rotational angular speed of the belt driving surface is greater than that of the crankshaft nose.

In one embodiment, the one-way clutch is a sensitive or precision clutch that can engage and disengage in about 0.2 to about 0.5 degree of rotation.

Although the invention is shown and described with respect to certain embodiments, it is obvious that modifications will occur to those skilled in the art upon reading and understanding the specification, and the present invention includes all such modifications.

What is claimed is:

1. A crankshaft damper comprising:
a hub mountable to a crankshaft;
an elastomeric member disposed in contact with the hub;
an inertia member seated against the elastomeric member thereby operably coupling the inertia member to the hub; and
a one-way clutch operably coupled to the inertia member, the one-way clutch having an engaged position and a disengaged position;
wherein the one-way clutch defines a belt-engaging surface or has a pulley body, defining a belt-engaging surface, seated thereagainst;
wherein when the one-way clutch is in the engaged position the belt-engaging surface rotates with the hub and when the one-way clutch is in the disengaged position, the belt engaging surface continues to rotate in the prevailing direction;
wherein when the one-way clutch transitions from the disengaged position to the engaged position, a magnification factor experienced by the inertia member in resonance is transferred by the one-way clutch to the belt engaging surface thereby providing the belt engaging surface an average rotational angular speed greater than the average rotational angular speed of the crankshaft or crankshaft nose.

2. The crankshaft damper of claim 1, wherein the inertia member is concentric with and spaced radially outward relative to the elastomeric member, and the one-way clutch is disposed concentric with and spaced radially outward relative to the inertia member.

3. The crankshaft damper of claim 1, wherein the inertia member is concentric with and spaced radially inward relative to the elastomeric member, and the one-way clutch is disposed concentric with and spaced radially inward relative to the inertia member.

4. The crankshaft damper of claim 1, wherein the one-way clutch is a sprag clutch.

5. The crankshaft damper of claim 1, wherein the one-way clutch is a mechanical diode one-way clutch.

6. The crankshaft damper of claim 3, wherein the pulley body defines the belt-engaging surface and defines an annular end cap that encloses a flange of the hub, the elastomeric member, the inertia member, and the one-way clutch between the portion defining the belt engaging surface and an opposing side wall.

7. The crankshaft damper of claim 1, wherein the pulley body defines the belt-engaging surface, and the one-way clutch has an inner ring and an outer ring both of which are independent of the inertia member and the pulley body.

8. The crankshaft damper of claim 1, wherein the pulley body defines the belt-engaging surface, and the one-way clutch includes an inner ring portion defined by the inertia member and an outer ring portion defined by the pulley body.

9. A front end accessory drive system comprising:
a crankshaft rotatable by an engine;
a crankshaft damper having a hub mounted to the crankshaft, an elastomeric member disposed in contact with the hub, an inertia member seated against the elastomeric member thereby operably coupling the inertia member to the hub, and a one-way clutch operably coupled to the inertia member, the one-way clutch having an engaged position and a disengaged position, and wherein the one-way clutch defines a belt-engaging surface or has a pulley body, defining a belt-engaging surface, seated thereagainst;
an endless belt operably engaged with the belt-engaging surface to be driven by the rotation of the crankshaft damper;
one or more driven pulleys engaged with the endless belt to be driven thereby; and
wherein the one-way clutch operates to increase an average RPM input to the front end accessory drive system relative to the average crankshaft input.

10. The front end accessory drive system of claim 9, wherein the inertia member is concentric with and spaced radially outward relative to the elastomeric member, and the one-way clutch is disposed concentric with and spaced radially outward relative to the inertia member.

11. The front end accessory drive system of claim 9, wherein the inertia member is concentric with and spaced radially inward relative to the elastomeric member, and the one-way clutch is disposed concentric with and spaced radially inward relative to the inertia member.

12. The front end accessory drive system of claim 9, wherein the one-way clutch is a sprag clutch or a mechanical diode one-way clutch.

13. The front end accessory drive system of claim 11, wherein the pulley body defines the belt-engaging surface and defines an annular end cap that encloses a flange of the hub, the elastomeric member, the inertia member, and the one-way clutch between the portion defining the belt engaging surface and an opposing side wall.

14. The front end accessory drive system of claim 9, wherein the pulley body defines the belt-engaging surface, and the one-way clutch has an inner ring and an outer ring both of which are independent of the inertia member and the pulley body.

15. The front end accessory drive system of claim 9, wherein the pulley body defines the belt-engaging surface, and the one-way clutch includes an inner ring portion defined by the inertia member and an outer ring portion defined by the pulley body.
